(19) United States
(12) Patent Application Publication
(10) Pub. No.: US 2023/0410606 A1
(43) Pub. Date: Dec. 21, 2023

(54) GAME SYSTEM THAT ACCUMULATES SYMBOLS TO INCREASE BONUS POINTS

(71) Applicant: JUMBO TECHNOLOGY CO., LTD., TAICHUNG (TW)

(72) Inventors: Tsung Yu HSU, TAICHUNG (TW); Min Chih YAO, TAICHUNG (TW)

(21) Appl. No.: 18/251,694

(22) PCT Filed: Dec. 24, 2020
(86) PCT No.: PCT/CN2020/138761

§ 371 Date: May 3, 2023

(51) Int. Cl. G07F 17/32

(52) U.S. Cl. CPC G07F 17/3267; G07F 17/3213

(57) ABSTRACT

A game system that accumulates symbols to increase bonus points. A slot game starts up a bonus game once a startup event an activation event is fulfilled, and the bonus game has at least one free round performed in sequence. In each of the free rounds, a game result generation unit generates group symbols. When a control unit determines that any one of the group symbols is a designated pattern that has an associated score, a display position of the designated pattern appears, and the designated pattern remains displayed in the bonus game. When the control unit determines that any one of the group symbols is a connecting symbol that has a predetermined rule, the connecting symbol is associated with the designated pattern that remains displayed in the bonus game, and the associated score of the designated pattern associated with the connecting symbol is changed according to the predetermined rule.

### FIELD OF THE INVENTION

The invention relates to a game system, and more particularly to a game system for accumulating symbols to increase reward points.

### BACKGROUND OF THE INVENTION

Please refer to FIG. 1, a slot machine 1 is a very popular game machine. The slot machine 1 includes a plurality of rollers 2, players can start the rollers 2 to spin after placing a bet, and points can be obtained according to the symbol arrangement formed after the rollers 2 stopping. When a specific symbol appears or satisfies a preset condition, a certain quantity of rounds of reward game can be entered. The reward game is characterized by free spin, it allows players to obtain additional reward points without spending additional costs, which is one of the important features of attracting players to use the slot machine.

Examples of common ways of playing reward games can be found in the process of respinning the rollers shown in FIG. 4 of the U.S. Pat. No. 8,197,328; as described in FIG. 1A, FIG. 1B, FIG. 3, FIG. 4, FIG. 5, FIG. 6 and lines 34 to 50 of column 6 of the specification of the U.S. Pat. No. 6,602,137, a reward game is disclosed; free game, retrigger and jackpot found in FIG. 3A, FIG. 3B, FIG. 4 and lines 2 to 57 of column 6 of the specification of the U.S. Pat. No. 6,955,600; and the U.S. Pat. No. 10,629,030 B2 discloses the points of mystery symbols that are determined based on the collected configurable symbols.

However, point fluctuation of the conventional reward games is not too large, for players who are familiar with the game, the general result of the conventional reward game can be easily inferred, and therefore the effect of stimulating the players cannot be exerted.

### SUMMARY OF THE INVENTION

A main object of the invention is to provide a game system with a reward game, which allows a player to accumulate at least one designated pattern with an associated point on a game screen in the reward game, the associated point can be changed by at least one linking symbol obtained randomly to make it possible for the player to obtain high points after multiple additions or multiple multiplications and increase a point fluctuation of the reward game, so as to maintain the player's interest for a long period of time and increase the time of using a slot machine.

In order to achieve the above object, the invention provides a game system for accumulating symbols to increase reward points. The game system provides a slot game, wherein the slot game starts a reward game after satisfying an activation event, and the reward game comprises at least one free round being played in sequence. The game system comprises a display unit, a game result generating unit and a control unit. The display unit comprises a game screen, wherein the game screen displays real-time game images of the slot game, and the game screen comprises a plurality of display positions arranged in a matrix. The game result generating unit generates a plurality of group symbols in the reward game, and the group symbols are displayed on the display positions of the game screen.

The control unit is connected to the display unit and the game result generating unit, and in each of the free rounds of the reward game sequentially played, the control unit performing following steps of: generating the group symbols through the game result generating unit; determining whether any one of the plurality of group symbols newly generated includes a designated pattern with an associated point; keeping displaying the designated pattern on the display position where the plurality of group symbols including the designated pattern in the reward game; associating the designated pattern which is kept displaying in the reward game with a linking symbol if any one of the plurality of group symbols newly generated includes the linking symbol with a predetermined rule; changing the associated point of the designated pattern associated with the linking symbol according to the predetermined rule; and determining whether the at least one free round of the reward game having been played; if yes, ending the reward game; if no, continuing to play the at least one free round in sequence.

Accordingly, in a process of performing the at least one free round, the invention allows the display position where the designated pattern appears to keep displaying the designated pattern in the reward game, and when any one of the group symbols is the linking symbol, the associated point of the designated pattern associated with the linking symbol can be changed. Therefore, in a process of performing the at least one free round, once the linking symbol appears, the associated point of the designated pattern can be changed and increased, so when the linking symbol continues to appear, the associated point of the designated pattern at a same position can be added or multiplied multiple times to generate high points, which can increase a point fluctuation of the reward game and make the player not to feel bored, and can still maintain anticipation and surprise to avoid the player to stop playing the reward game.

### BRIEF DESCRIPTION OF THE DRAWINGS

FIG. 1 is a perspective view of a conventional slot machine;

FIG. 2 is a block diagram of a system of the invention;

FIG. 3 is a perspective view of a game machine of the invention;

FIG. 4 is an operational flow chart of a reward game of the invention;

FIGS. 5A-5G are schematic diagrams of game screens according to a first embodiment of the invention; and

FIGS. 6A-6H are schematic diagrams of the game screens according to a second embodiment of the invention.

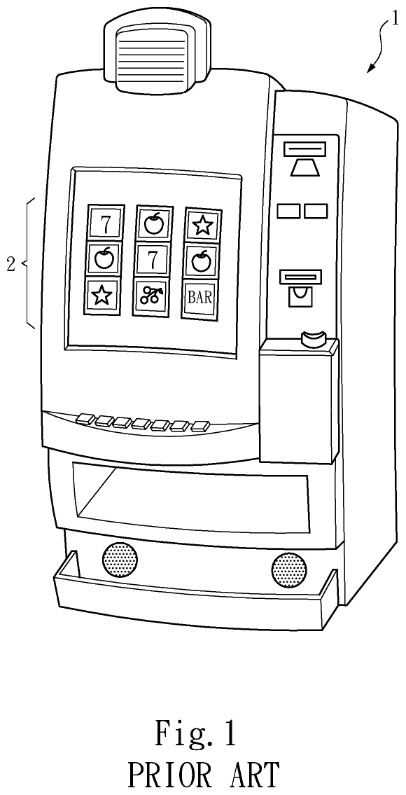

### DETAILED DESCRIPTION OF THE PREFERRED EMBODIMENTS

The detailed description and technical content of the invention are described below with reference to the drawings.

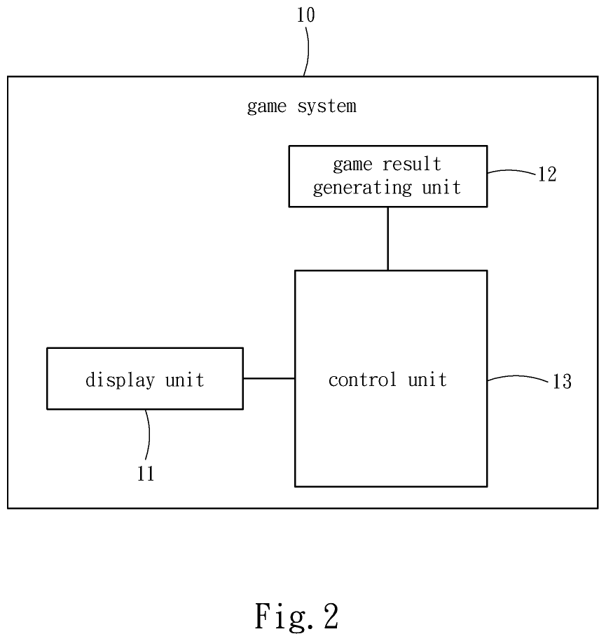

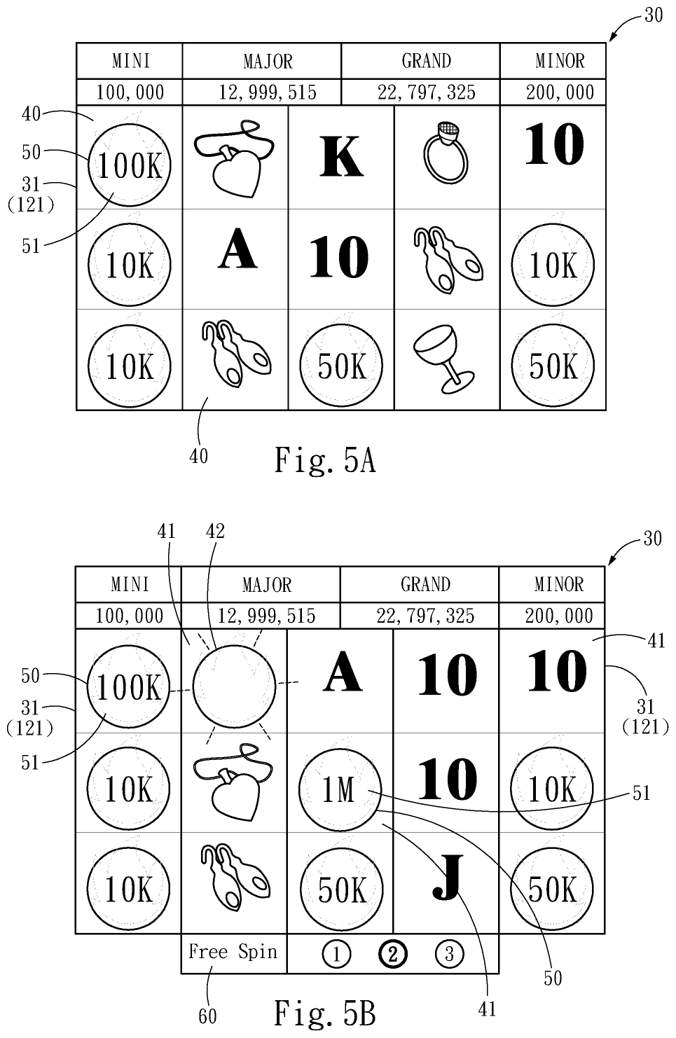

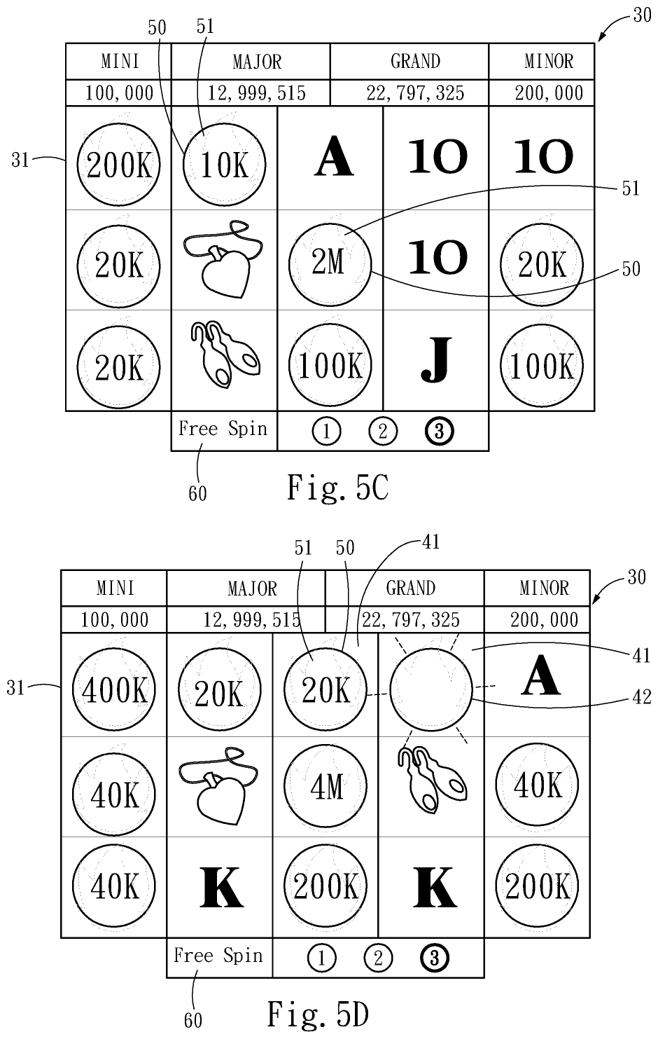

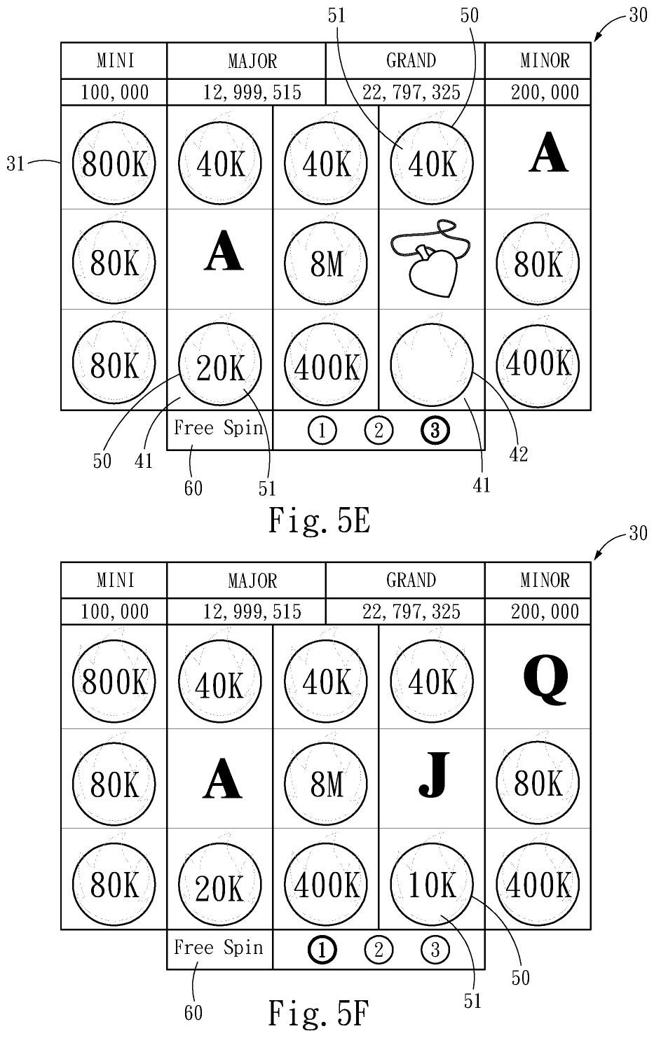

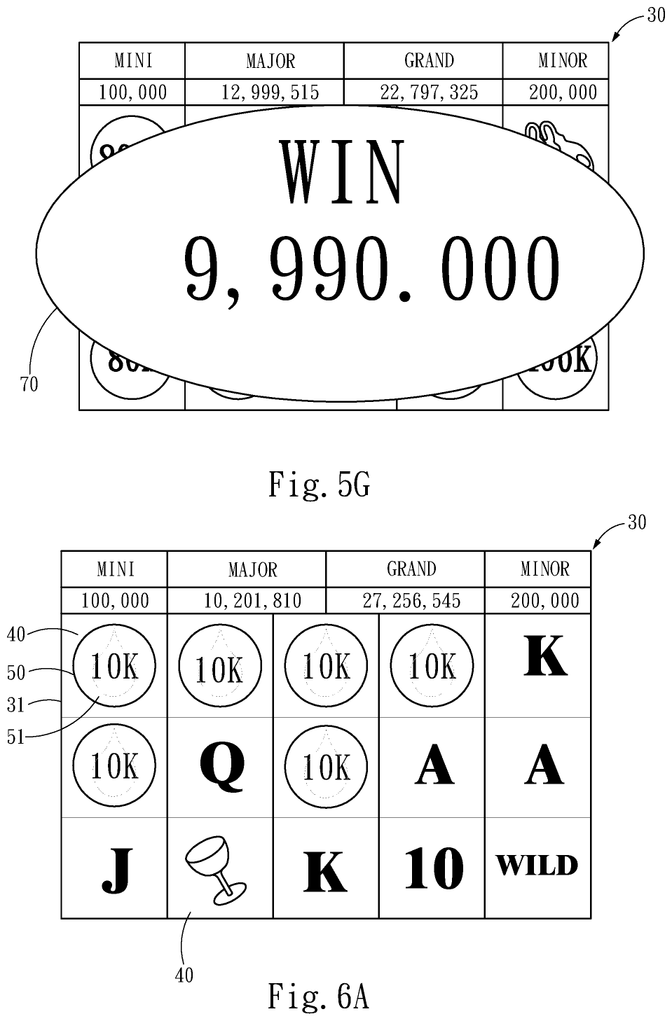

Please refer to FIG. 2, FIG. 3 and FIG. 5A. The invention discloses a game system 10 for accumulating symbols to increase reward points. The game system 10 is disposed in a game machine and the game system 10 provides a slot game through the game machine 20. The game system 10 comprises a display unit 11, a game result generating unit 12 and a control unit 13. The display unit 11 includes a game screen 30 to display real-time game images of the slot game, and the game screen 30 includes a plurality of display positions 31 arranged in matrix. The slot game starts a reward game after satisfying an activation event, and the reward game includes at least one free round that is played in sequence. In more detail, the slot game generates a plurality of game symbols 40 through the game result generating unit 12, and displays the plurality of game symbols 40 on the plurality of display positions 31 of the game screen 30 to determine a game result. When the plurality of game symbols 40 of the game result comprise a designated quantity of at least one designated pattern 50, the slot game satisfies the activation event (as shown in FIG. 5A), and the reward game can be played accordingly.

Please refer to FIG. 5B. In one embodiment, the game screen 30 includes a round display field 60 to display a total quantity and remaining times of the at least one free round, so that a player can clearly know a quantity of free rounds that have not been played in the reward game. If the round display field 60 includes patterns of circled numbers 1-3, it represents that the quantity of free rounds in total is three, and the bold circled number represents the remaining times of the free rounds. For example, FIG. 5B shows that there are 2 remaining times (including an ongoing free round). In addition, the game result generating unit 12 generates a plurality of group symbols 41 in the reward game, the plurality of group symbols 41 are displayed on the plurality of display positions 31 of the game screen 30, and patterns of the plurality of group symbols 41 can be the same as or different from the plurality of game symbols 40. Differences between the plurality of group symbols 41 and the plurality of game symbols 40 including: the plurality of game symbols 40 are used for proceeding the slot game to determine the game result; the plurality of group symbols 41 are used for proceeding the reward game to determine total points of the reward game. After the slot game satisfies the activation event (as shown in FIG. 5A), each of the plurality of display positions 31 appears the at least one designated pattern 50 and keep displaying the at least one designated pattern 50 until the reward game ends, and an associated point 51 of the at least one designated pattern 50 can be displayed on each of the plurality of display positions 31 that appears the at least one designated pattern 50.

In addition, the game result generating unit 12 can be a plurality of roller units 121 in an actual implementation, and the plurality of roller units 121 generates the plurality of game symbols 40 or the plurality of group symbols 41 by spinning and then stopping. In one embodiment, a quantity of the plurality of roller units 121 corresponds to a quantity of the plurality of display positions 31, that is, each of the plurality of display positions 31 is provided with one of the plurality of roller units 121, and each of the plurality of roller units 121 independently generates one of the plurality of game symbols 40 or one of the plurality of group symbols 41. In another embodiment, the plurality of display positions 31 at one column displays the plurality of game symbols 40 or the plurality of group symbols 41 generated by one roller unit. That is, the plurality of game symbols 40 or the plurality of group symbols 41 at the same column are displayed by continuously spinning from top to bottom. For example, if the game screen 30 comprises the plurality of display positions 31 arranged in a 3×5 matrix to display the plurality of game symbols 40 or the plurality of group symbols 41, this embodiment is implemented with five roller units, and each of the roller units simultaneously displays three rows of the plurality of game symbols 40 or the plurality of group symbols 41 on the game screen 30. When spinning, the plurality of game symbols 40 or the plurality of group symbols 41 will move from a first row to a second row, finally move to a third row, and then disappear from the game screen 30.

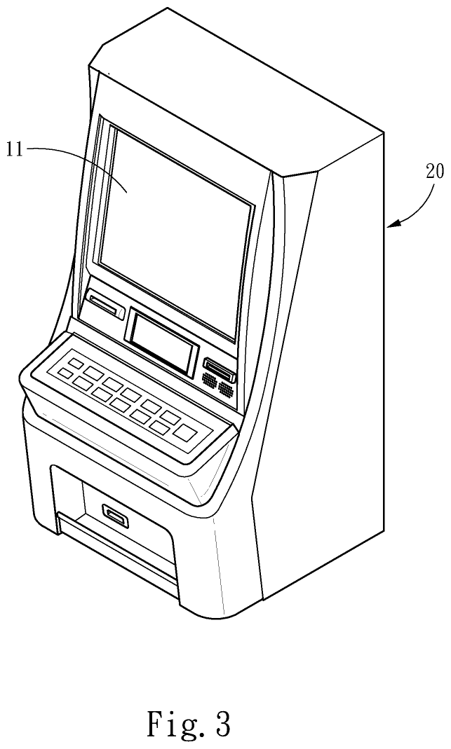

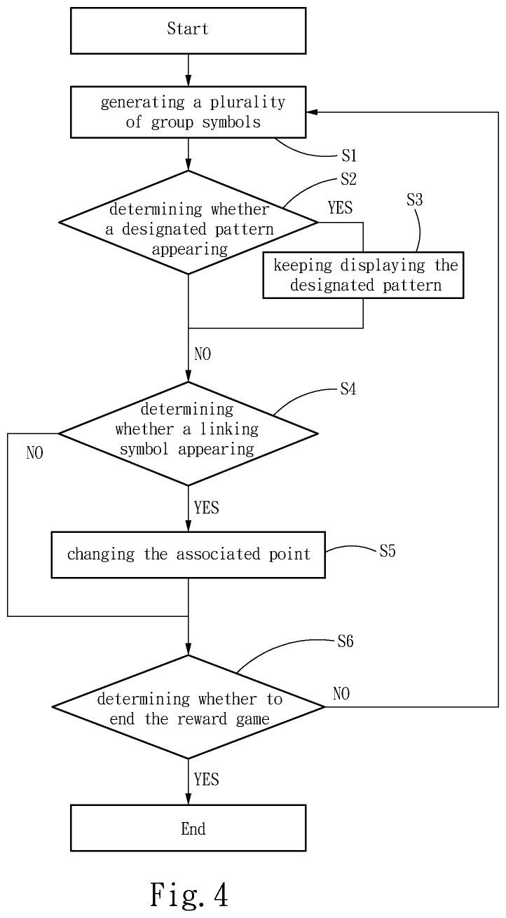

Please refer to FIG. 2, FIG. 4, FIG. 5A, FIG. 5B, FIG. 5C, FIG. FIG. 5E and FIG. 5F. The control unit 13 is connected to the display unit 11 and the game result generating unit 12, and the control unit 13 performs steps S1 to S6 while proceeding with the at least one free round of the reward game in sequence.

Firstly, step S1: generating the plurality of group symbols 41. The plurality of group symbols 41 is generated through the game result generating unit 12 in step S1. Then, step S2: determining whether any one of the plurality of group symbols 41 newly generated includes the at least one designated pattern 50 of the associated point 51. If step S2 determines to be YES, proceeding to step S3: keeping displaying the at least one designated pattern 50. In step S3, the at least one designated pattern 50 is displayed continuously on the display position 31 where the plurality of group symbols including the designated pattern 50 in the reward game, and proceeding to step S4. If step S2 determines to be NO, proceeding to step S4: determining whether a linking symbol 42 appearing. In step S4, the linking symbol 42 with a predetermined rule is determined whether be included in the plurality of group symbols 41 newly generated. If step S4 determines to be YES, associating the linking symbol 42 with the at least one designated pattern 50 kept display in the reward game, and proceeding to step S5: changing the associated point 51. In step S5, the associated point 51 of the at least one designated pattern 50 associated with the linking symbol 42 is changed according to the predetermined rule, and proceeding to step S6. If step S4 determines to be NO, proceeding to step S6: determining whether to end the reward game. In step S6, the at least one free round of the reward game is determined whether have been played, and the at least one free round is determined whether has been ran out. If step S6 determines to be YES, ending the reward game; if step S6 determines to be NO, returning to step S1 and continuing to play the at least one free round in sequence.

Please refer to FIG. 2, FIG. 5A, FIG. 5B, FIG. 5C, FIG. 5D, FIG. 5E and FIG. 5F, showing the first embodiment of the invention. Firstly, as shown in FIG. 5A, the plurality of game symbols 40 comprises six designated patterns 50 with associated points 51 (respectively located at matrix positions (1,1), (2,1), (2,5), (3,1), (3,3), (3,5)), the slot game satisfies the activation event, and the reward game is started.

After entering the reward game, the game result generating unit 12 generates the plurality of group symbols 41 which are new in each round. The plurality of group symbols 41 newly generated are displayed on the plurality of display positions 31 of the game screen and the plurality of display positions 31 where the six designated patterns 50 originally appeared in the slot game will be kept displaying until ending of the reward game. FIG. 5B is the real-time game image of a second time of spinning in the at least one round, that is to say, the at least one free round has been proceeded once and left two times of spinning remained (a bold circled number in the round display field 60 is two). In FIG. 5B, a designated pattern 50 (matrix position (2,3)) and a linking symbol 42 (matrix position (1,2)) appear in the plurality of group symbols 41 newly generated, and a value of a associated point 51 indicated by said designated pattern 50 is “1 M”.

In this embodiment, the predetermined rule of the linking symbol 42 is: associating all the designated patterns 50 on the plurality of display positions 31, and doubling the associated points 51 associated with the designated patterns 50. The linking symbol 42 in this embodiment is diagrammed as “fire”, thereby all the designated patterns 50 comprises “fire” that are identified as a watermark in figures, and presentation on an actual screen can be more colorful and obvious.

Therefore, as shown in FIG. 5C, the associated points 51 associated with the designated patterns 50 are doubled; for example, the value “1 M” of one of the associated points 51 in FIG. 5B will become “2 M” in FIG. 5C. In order to attract the player's attention, the game screen 30 can present an animated image which includes a process that the associated points 51 of the designated patterns 50 are doubled. In addition, after presentation of the animated image ends, the linking symbol 42 (matrix position (1,2)) will be transformed into another designated pattern 50 with the associated point 51 (value “10K”).

In addition, after one of the designated patterns 50 or the linking symbols 42 newly appears in any one of the plurality of group symbols 41, the control unit 13 will restore the remaining times of the at least one free round. That is, when the quantity of the at least one free round obtained by the player in total is three, no matter how many times of the at least one free round have been left for the player, the player can restore to have three free rounds remained. For example, as shown in FIG. 5B, the at least one free round has been proceeded and left two times of spinning remained (a bold circled number in the round display field 60 is two), but a bold circled number in the round display field 60 shown in FIG. 5C will be restored to number three since the linking symbol 42 has newly appeared.

Then, as shown in FIG. 5D, one designated pattern 50 (matrix position 1×3) and one linking symbol 42 (matrix position 1×4) newly generated appear in the plurality of group symbols 41. Similarly, the associated points 51 of all the designated patterns 50 are doubled based on an existing point, and then said linking symbol 42 will be transformed into another designated pattern 50 with the associated point 51 (as shown in FIG. 5E).

Then, as shown in FIG. 5E, one designated pattern 50 (matrix position (3,2)) and one linking symbol 42 (matrix position (3,4)) newly generated appear in the plurality of group symbols 41. Similarly, the associated points 51 of all the designated patterns 50 are doubled based on an existing point, and said linking symbol 42 will be transformed into another designated pattern 50 with the associated point 51 (as shown in FIG. 5F).

As shown in FIG. 5F, when the remaining times of the at least one free round is one, and if no designated pattern 50 or linking symbol 42 newly generated appear in the ongoing round, the reward game is ended. Finally, as shown in FIG. 5G, after the reward game is ended, a point display field 70 appears on the game screen 30, and the point display field 70 displays a total point of the reward game. The total point of the reward game is a sum of the associated points 51 of the at least one of designated patterns 50. In other embodiments, the total point of the reward game can further include other reward points, depending on a design of the game.

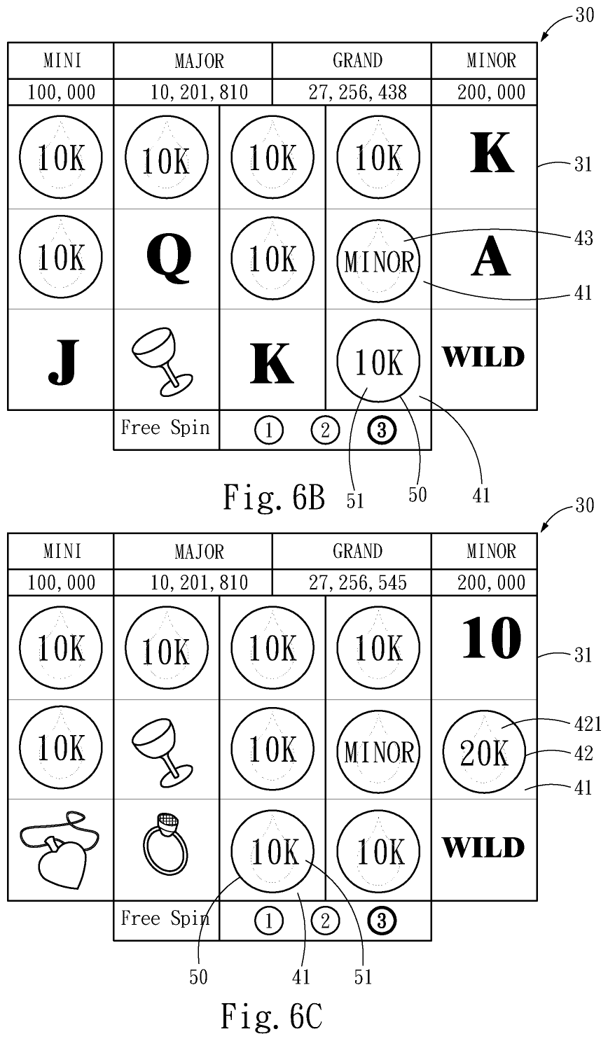

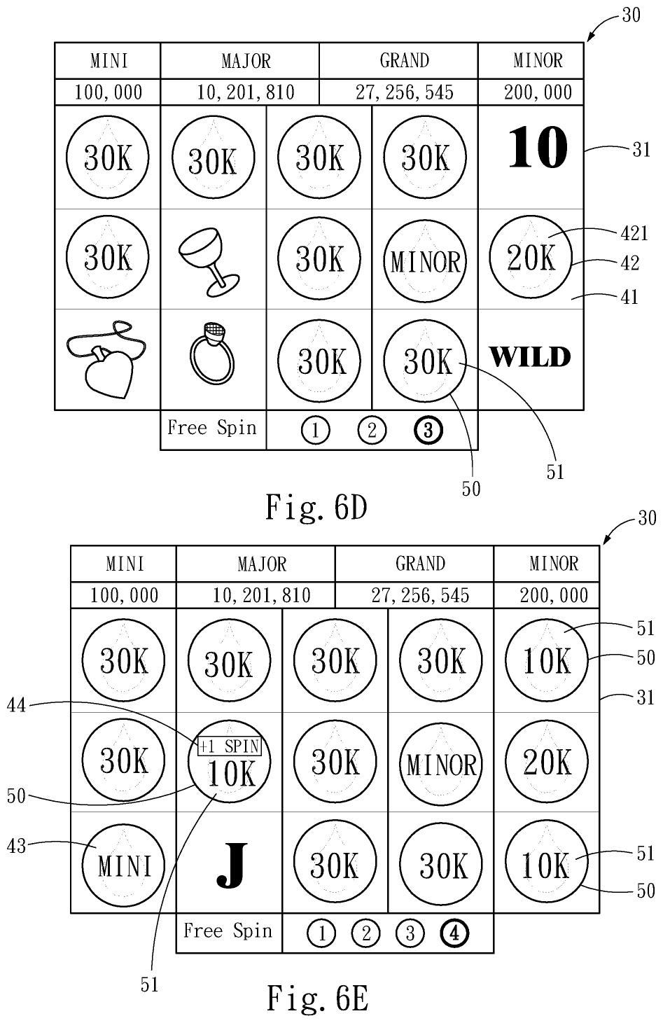

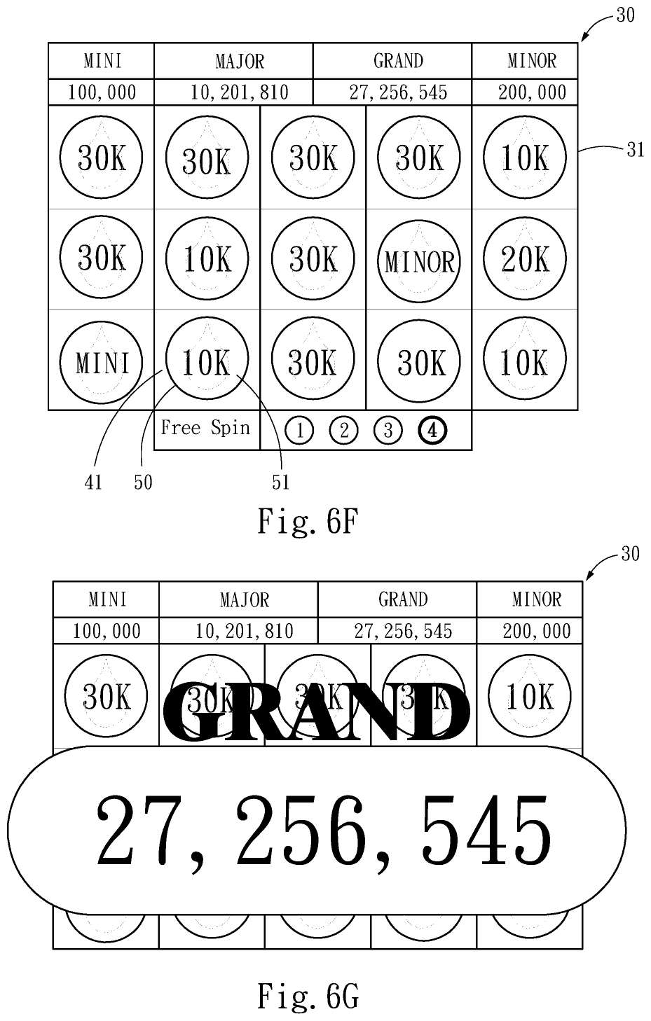

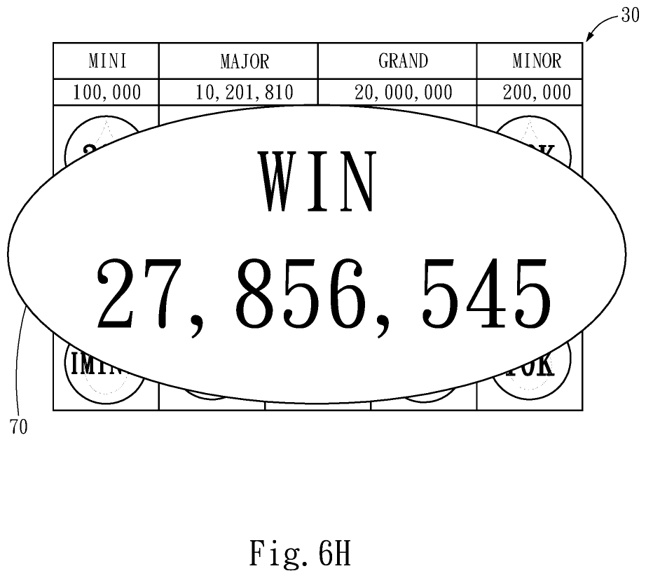

Please refer to FIG. 6A, FIG. 6B, FIG. 6C, FIG. 6D, FIG. 6E, FIG. 6F, FIG. 6G and FIG. 6H for a second embodiment of the invention. In this embodiment, as shown in FIG. 6A, the plurality of game symbols 40 comprise six designated patterns 50 with six associated points 51 (respectively located at matrix positions (1,1), (1,2), (1,3), (1,4), (2,1), (2,3)), the slot game satisfies the activation event, and the reward game is started. In FIG. 6B, one designated pattern 50 with an associated point 51 (matrix position (3,4)) and one jackpot symbol 43 (MINOR) (matrix position (2,4)) newly generated appear in the plurality of group symbols 41. When the jackpot symbol 43 (MINOR) appears, the player can obtain a point corresponding to the jackpot symbol 43 (MINOR), wherein the point is “200,000” in this embodiment. In different embodiments, when other jackpot symbols 43 such as MINI, MAJOR, GRAND are obtained, corresponding points can be obtained.

Then, as shown in FIG. 6C, one designated pattern 50 (matrix position (3,3)) and one linking symbol 42 (matrix position (2,5)) newly generated appear in the plurality of group symbols 41. In this embodiment, the linking symbol 42 includes a link point 421 associating with all the designated patterns 50 on the display positions 31, and the predetermined rule of the linking symbol 42 is: changing the associated points 51 of the associated designated patterns 50 by adding the link point 421. As shown in FIG. 6D, the link point 421 is 20 K, so the associated points 51 of the designated patterns 50 associated with the linking symbol 42 are increased 20 K points. In addition, the linking symbol 42 in this embodiment is diagrammed as “water”, thereby all the designated patterns 50 comprises the symbol “water”.

Then, as shown in FIG. 6E, three designated patterns 50 (matrix positions (1,5), (2,2), (3,5)) and one jackpot symbol 43 (MINI) (matrix position 3×1) newly generated appear in the plurality of group symbols 41, that is, the player can additionally obtain points corresponding to the associated points 51 of said three designated patterns 50 and said jackpot symbol 43 (MINI). Further, in this embodiment, one of designated patterns 50 (matrix position (2,2)) additionally includes a field quantity symbol 44, and the control unit 13 correspondingly increases a total quantity of the at least one free round according to a quantity of the field quantity symbol 44. For example, in this embodiment, the quantity of the at least one free round will be change from three to four, and when one designated pattern 50, the linking symbol 42 or the jackpot symbol 43 newly appears in any one of the plurality of group symbols 41, the control unit 13 will restore the remaining times of the at least one free round, that is, the player can restore to have four free rounds remained in this embodiment.

Then, as shown in FIG. 6F, one designated patterns 50 (matrix position (3,2)) newly generated appears in the plurality of group symbols 41, and the player can additionally obtain the associated point 51 of said designated pattern 50. At this time, each of the plurality of display positions 31 already includes the designated pattern 50, the linking symbol 42, or the jackpot symbol 43, and is unable to display the plurality of group symbols 41. In this situation, the player obtains a maximum jackpot (GRAND), that is, points corresponding to GRAND, as shown in FIG. 6G. Finally, as shown in FIG. 6H, the point display field 70 appears on the game screen and the point display field 70 displays a total point obtained by the player at the end of the reward game, wherein the associated points 51 of the at least one designated pattern 50 and a total point of all the jackpot symbols 43 are included.

In another embodiment, the control unit 13 enables the linking symbol 42 to be selected to associate with the at least one designated pattern 50 kept displaying in the reward game according to the predetermined rule. In more detail, the first embodiment can be implemented together with the second embodiment, that is, the designated patterns 50 diagrammed as “fire” in the first embodiment and the designated patterns 50 diagrammed as “water” in the second embodiment can be appeared at the same time, and the linking symbol 42 can be selected to associated with one or both of the designated patterns 50 diagrammed as “fire” and “water”, and after association, the associated points 51 of the associated designated patterns 50 are changed according to the predetermined rule. In this way, varied ways of playing can be formed to attract the player and prevent the player from feeling bored.

In summary, advantages of the invention at least include:
1. In a process of playing the reward game, once the linking symbol appears, the associated point of the at least one designated pattern can be changed and increased. Therefore, when the linking symbol continues to appear, the associated point of the at least one designated pattern on the same position can be added or multiplied multiple times to generate high points, which can increase a point fluctuation of the reward game, so that the player will not feel bored, and still maintain expectation and surprise, and can avoid the player to stop playing the reward game, and can make the slot game more appealing.
2. Under the same operation mode, the linking symbol can be used in various different rules according to the player's preferences, and the system vendor does not need to put a lot of money for design. Varied ways of playing can be formed through the same operation mode in order to attract the player and prevent the player from feeling bored.
3. A point obtained is added or multiplied multiple times, which can quickly increase a value of the point, and a mechanic is provided to restore a remaining times of the at least one free round, so the player will not feel bored because the expected result is not good. Before the end of the game, expectation and surprise can be maintained, and amusement can be enhanced.

1. A game system for accumulating symbols to increase reward points, the game system providing a slot game which starts a reward game after satisfying an activation event, and the reward game having at least one free round being played in sequence, the game system comprising:
a display unit, comprising a game screen displaying real-time game images of the slot game, wherein the game screen comprises a plurality of display positions arranged in a matrix;
a game result generating unit, generating a plurality of group symbols in the reward game, wherein the plurality of group symbols are displayed on the plurality of display positions of the game screen; and
a control unit, connected to the display unit and the game result generating unit, and in each of the at least one free round of the reward game sequentially played, the control unit performing following steps of:
generating the plurality of group symbols through the game result generating unit;
determining whether any one of the plurality of group symbols newly generated includes a designated pattern with an associated point;
keeping displaying the designated pattern on the display position where the plurality of group symbols including the designated pattern in the reward game;
associating the designated pattern which is kept displaying in the reward game with a linking symbol if any one of the plurality of group symbols newly generated includes the linking symbol with a predetermined rule;
changing the associated point of the designated pattern associated with the linking symbol according to the predetermined rule; and
determining whether the at least one free round of the reward game having been played; if yes, ending the reward game; if no, continuing to play the at least one free round in sequence.

2. The game system as claimed in claim 1, wherein the control unit enables the linking symbol to be selected to associate with the designated pattern kept displaying in the reward game according to the predetermined rule.

3. The game system as claimed in claim 1, wherein the game result generating unit is a plurality of roller units, and the plurality of roller units generates the plurality of group symbols by spinning and then stopping.

4. The game system as claimed in claim 3, wherein a quantity of the plurality of roller units corresponds to a quantity of the plurality of display positions.

5. The game system as claimed in claim 3, wherein the plurality of group symbols displayed on the plurality of display positions in a same column are generated by one of the plurality of roller units.

6. The game system as claimed in claim 1, wherein the slot game generates a plurality of game symbols through the game result generating unit to determine a game result, and if the plurality of game symbols includes a designated quantity of at least one of the designated pattern, the slot game satisfies the activation event.

7. The game system as claimed in claim 6, wherein after the slot game satisfies the activation event, each of the plurality of display positions that appears the designated pattern will keep displaying the designated pattern until the reward game ends.

8. The game system as claimed in claim 1 or 7, wherein the associated point of the designated pattern is displayed on each of the plurality of display positions that appears the designated pattern.

9. The game system as claimed in claim 1, wherein if the designated pattern comprises a field quantity symbol additionally, the control unit correspondingly increases a quantity of the free round according to a quantity of the field quantity symbol.

10. The game system as claimed in claim 1 or 9, wherein if any one of the plurality of group symbols newly generated includes the designated pattern, the control unit restores a remaining times of the at least one free round.

11. The game system as claimed in claim 1 or 9, wherein if any one of the plurality of group symbols newly generated includes the linking symbol, the control unit restores a remaining times of the at least one free round.

12. The game system as claimed in claim 1, wherein after the reward game is ended, a point display field appears on the game screen, and the point display field displays a total point of the reward game.

13. The game system as claimed in claim 1, wherein the game screen comprises a round display field which displays a total quantity and a remaining times of the at least one free round.

14. The game system as claimed in claim 1, wherein after the control unit changes the associated point of the designated pattern associated with the linking symbol, the linking symbol is transformed into the designated pattern with the associated point.
